(19) United States
(12) Patent Application Publication
(10) Pub. No.: US 2019/0329991 A1
(43) Pub. Date: Oct. 31, 2019

(54) Carrier For Holding A Plurality Of Articles

(71) Applicant: Rolls-Royce plc, London (GB)

(72) Inventors: Paul J. Wilson, Derby (GB); Aleksander M. Cendrowicz, Derby (GB); Akshay Bhatt, Derby (GB); Athira Rajiv, Bangalore (IN); Per Nohlert, Alesund (NO); David A. Bell, Glasgow (GB)

(21) Appl. No.: 16/385,886

(22) Filed: Apr. 16, 2019

(30) Foreign Application Priority Data
Apr. 30, 2018 (GB) 1806996.3

(51) Int. Cl. B65G 49/04; C04B 41/48; C04B 41/45; C04B 41/53

(52) U.S. Cl. CPC B65G 49/0409; C04B 41/53; C04B 41/4525; C04B 41/4819

(57) ABSTRACT

An article 7 made from a porous material, such as a ceramic material, is dipped into a liquid impregnating material 12, such as molten urea in a bath 14. After withdrawal from the bath 14, excess impregnating material 12 is removed from the article 6 by means of an air knife 22. The article is carried by a carrier or fixture 6 to be conveyed along the processing line on a conveyor 2. The fixture 6 comprises a lower support 32 in the form of a pair of parallel bars which define between them a slot 38. The fixture also has clamping devices 42 for holding an upper region of the article 7, while the weight of the article 7 is supported by the lower support 32.

### CROSS-REFERENCE TO RELATED APPLICATIONS

This application is based upon and claims the benefit of priority from UK Patent Application Number 1806996.3 filed on 30 Apr. 2018, the entire contents of which are incorporated herein by reference.

### BACKGROUND

### Field of the Disclosure

This disclosure relates to a carrier for holding a plurality of articles and particularly, although not exclusively, for holding articles such as ceramic cores for use in the investment casting of metallic components.

### Description of the Related Art

Ceramic cores are used in investment casting processes, for example for the manufacture of components of gas turbine engines such as turbine blades, nozzle guide vanes and seal segments, in order to produce internal passages and other cavities within the component. When casting is complete, the core is flushed out. Ceramic cores used for this purpose are about 25% to 35% porous and are inherently fragile. In order to enable them to withstand the stresses applied to them during the casting process and the associated mechanical handling, it is known to subject them to increased surface strength processes. U.S. Pat. No. 5,460,854, for example, discloses impregnation of ceramic cores by dipping them in a liquid such as an aqueous solution of water-soluble gum, resin or sugar. The impregnated core is then dried to remove the water.

GB1314145 discloses a method of impregnating a porous ceramic core with molten urea. The core is dipped in the molten urea and, after withdrawal, is dabbed or wiped using absorbent paper tissue to remove excess urea. It is known to place the ceramic cores manually on a perforated tray which is immersed in the liquid impregnating material.

Working with molten urea involves dangers to operators. The temperature of molten urea is in excess of 134° C., and manual wiping or dabbing of hot impregnated ceramic cores carries the risk of burning. Furthermore, at higher temperatures, such as temperatures exceeding 170° C., urea decomposes to form toxic gases such as ammonia and carbon monoxide, which also expose operators to risks.

Excessive handling of the ceramic cores can damage them, as can movement of the cores in the perforated tray is during the dipping process. Manual dabbing and wiping of the impregnated cores introduces variations into the treatment of the cores and also creates the risk that the cores, and in particular thinner sections of them, may be damaged during removal of the excess urea. Furthermore, if the impregnated core has cooled sufficiently for the urea to solidify, it is difficult to remove the solidified urea from holes and similar features on the cores. Any solidified urea that remains on the surface of impregnated components can affect the subsequent processes, and in particular the residual urea can affect the dimensional accuracy of the final cast component.

### SUMMARY

According to one aspect of the present disclosure there is provided a carrier for holding a plurality of articles during displacement to and from a dipping position, at least, the carrier comprising a frame having an elongate lower support for supporting a row of the articles, and having an upper support provided with clamping devices for holding the articles positions above the lower support, the lower support having a drainage aperture for the drainage of liquid from the articles, and the carrier further comprising a mounting arrangement for mounting the carrier on a conveyor.

The drainage aperture may comprise a slot extending lengthwise of the lower support. The width of the slot may be not less than 5 mm and not more than 10 mm.

The lower support may comprise a pair of parallel bars which are spaced apart to define the drainage slot. The bars may be solid metal components. The bars may be of quadrilateral cross-section oriented so that oppositely disposed surfaces of the respective bars define a downwardly convergent channel.

Each clamping device may comprise a pair of arms provided with contact ends for engagement with an article, the arms being resiliently displaceable relatively to each other to move the contact ends apart.

The arms may be made from metallic wire, in which case the contact ends may comprise end faces of the metallic wire.

The arms may be secured at respective ends away from the contact ends to the upper support, for example by welding.

The present disclosure also provides an article dipping system comprising a bath of liquid, a conveyor, and least one carrier in accordance with the present disclosure, the carrier being mounted on the conveyor for displacement to and from a dipping position over the bath, and the conveyor being equipped with a lowering mechanism operable at the dipping position to immerse in the liquid articles carried by the carrier.

The system may further comprise an excess liquid removal station, the conveyor being operable, after immersion of the articles, to raise the carrier from the bath and to convey the carrier to the excess liquid removal station.

A carrier in accordance with the present disclosure may be employed to hold an article made from a porous material in a method of impregnating a surface region of the article, the method comprising:

i) immersing the article in a liquid impregnating material;

ii) withdrawing the article from the liquid impregnating material; and

iii) removing excess impregnating material from the surface of the article by exposing the article to a flow of gas.

The impregnating material may be a material which is in a solid-state at ambient temperature, in which case the gas in the flow of gas may be discharged at a temperature higher than the melting point of the impregnating material. The melting point of the impregnating material may be higher than 100° C., and may be higher than 130° C.

The gas in the flow of gas may be discharged at a temperature higher than 150° C.

The impregnating material may be urea.

Between withdrawal of the article from the liquid impregnating material and exposure of the article to the flow of gas, at least some of the impregnated material may solidify, and the temperature of the gas in the gas flow may be sufficient to return the solidified impregnated material to the liquid state.

In order to expose the article to the flow of gas, the article may be displaced across the flow of gas.

The article may be withdrawn from the liquid impregnating material into a transfer region and be conveyed from the transfer region to a removal region at a higher temperature than the transfer region, the article being exposed to the flow of gas in the removal region.

The transfer region may be separated from the removal region by a separation gas flow. The article may travel into the removal region in a travel direction transverse to the direction of the separation gas flow.

The flow of gas to remove excess impregnating material may be directed obliquely with respect the separation gas flow.

The flow of gas and/or the separation gas flow may comprise an air knife.

The article may be a ceramic article, such as a ceramic core for use in an investment casting process.

A carrier in accordance with the present disclosure may be employed to hold an article made from a porous material in a method of impregnating with urea a surface region of the article, the method comprising:

i) immersing the article in molten urea;

ii) withdrawing the article from the molten urea; and

iii) removing excess urea from the surface of the article by exposing the article to a flow of gas, at a temperature higher than the melting point of urea.

Apparatus for use in a method of impregnating a surface region of an article made from a porous material may comprise:

i) a carrier in accordance with the present disclosure, for holding the article;

ii) a bath of liquid impregnating material;

iii) an excess impregnating material removal station provided with a blower generating the flow of gas; and

iv) a conveyor for conveying the carrier and the article from the bath of liquid to the removal station and into the path of the flow of gas.

The excess impregnating material removal station may comprise an enclosure having an opening for the passage of the article into the enclosure, the blower discharging the flow of gas into the enclosure.

If the apparatus is for use in a method in which the article is conveyed from a transfer region to a removal region at a higher temperature than the transport region, a further blower may be positioned at the opening to deliver a separation gas flow, to separate the transfer region from the removal region.

Alternatively, or in addition, a partition may extend across the opening to separate the transfer region from the removal region. The partition may be provided with an aperture permitting passage of the article between the transfer region and the removal region.

Alternatively, According to one aspect of the present disclosure, there is provided a carrier for holding a plurality of articles, the carrier comprising a frame having an elongate lower support for supporting a row of the articles, and having an upper support provided with clamping devices for holding the articles positions above the lower support, the lower support having a drainage aperture for the drainage of liquid from the articles, and the carrier further comprising a mounting arrangement for mounting the carrier on a conveyor.

The skilled person will appreciate that except where mutually exclusive, a feature described in relation to any one of the above aspects may be applied mutatis mutandis to any other aspect. Furthermore except where mutually exclusive any feature described herein may be applied to any aspect and/or combined with any other feature described herein.

### BRIEF DESCRIPTION OF THE DRAWINGS

Arrangements will now be described, by way of example, with reference to the accompanying drawings, in which:

FIG. 1 is a diagrammatic representation of a urea impregnation processing line;

FIG. 2 is a side view of an excess urea removal station in the processing line of FIG. 1;

FIG. 3 is a view from above of an alternative excess urea removal station;

FIG. 4 is a side view of a fixture for carrying articles for impregnation in the processing line of FIG. 1;

FIG. 5 is an edge view of the fixture of FIG. 4;

FIG. 6 is an enlarged view of a clamp arm of the fixture shown in FIGS. 4 and 5; and

FIG. 7 is a flow diagram of an impregnation process carried out on the processing line shown in FIG. 1.

### DETAILED DESCRIPTION OF THE DISCLOSURE

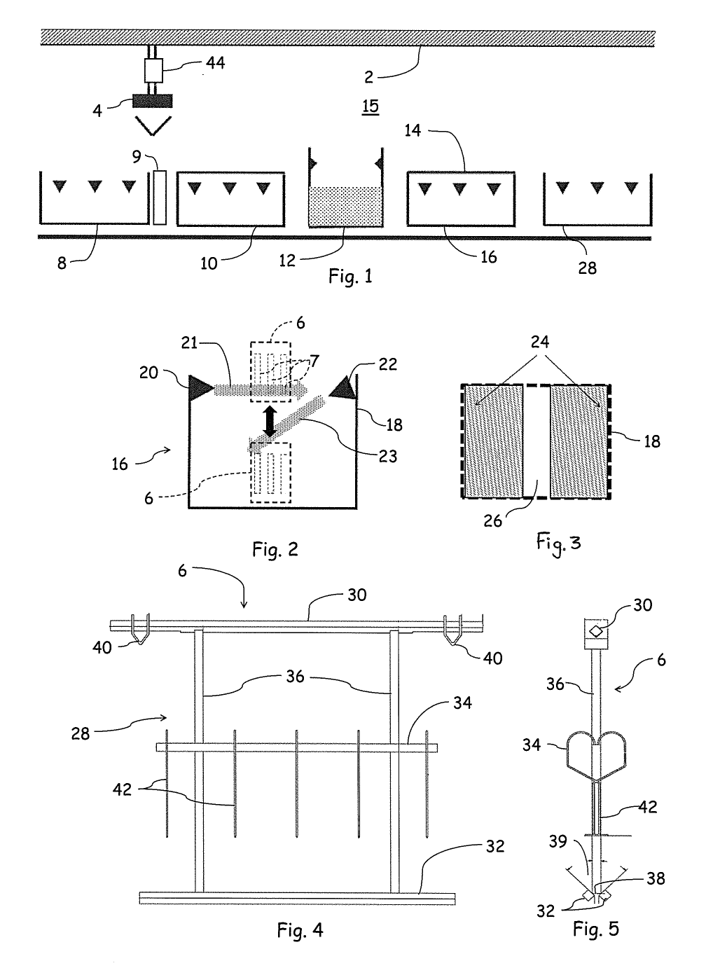

The processing line of FIG. 1 comprises a conveyor represented by a rail 2 provided with a transport carrier 4 which can travel along the rail 2. The carrier 4 is equipped to carry a fixture 6 (see FIG. 4) which can be loaded with articles 7 to be impregnated. In the embodiment to be described, the articles 7 are porous ceramic cores which are to be impregnated with urea. However, it will be appreciated that a similar process can be employed for treating different articles 7 with different impregnating or coating compositions.

The processing line shown in FIG. 1 comprises a loading station 8 at which the ceramic cores 7 are loaded onto the fixture 6. Loading can be effected either manually by an operator, or by an automated process. Once loaded, the fixture 6 is placed in a dedicated stand 9. The transport carrier 4 then automatically engages the fixture 6 and lifts it from the stand 9. The fixture is then conveyed by the transport carrier 4 along the rail 2 to a pre-heating station 10. At the pre-heating station 10, the fixture 6 and the cores 7 loaded on it are heated by any suitable means, for example by passing through an oven, or past radiant heaters. The cores 7 may, for example, be heated to a temperature in excess of 100° C., for example in excess of the melting point of urea (134° C.). Such pre-heating of cores 7 of larger section avoids the risk of damage to the cores 7 as a result of thermal shock when subsequently immersed in molten urea. Pre-heating is less necessary for smaller section cores for which thermal shock is less severe, and so the pre-heating operation may be omitted for such components.

Following pre-heating, the fixture 6 is conveyed by the transport carrier 4 to a dipping station 12 where the fixture 6 is positioned at a point directly above a bath 14 of molten urea maintained at a temperature in excess of the melting point of urea (134° C.) but lower than 170° C. at which urea begins to decompose. The temperature may be between 150° C. and 165° C., for example 160° C. The fixture 6 is then lowered by the transport carrier 4 into the molten urea in the bath 14 so that the cores 7 carried by the fixture 6 are fully immersed in the molten urea. For this purpose, the transport carrier is provided with a lifting and lowering mechanism 44.

The fixture 6 is then raised from the bath 14 by the lifting and lowering mechanism 44 and conveyed by the transport carrier 4 along the rail 2 through a transfer region 15 to an excess urea removal station 16, shown in more detail in FIG. 2. The urea removal station 16 is provided with a vessel 18 having a top opening 19. The vessel 18 is equipped with a first blower 20 and a second blower 22 which are fixed in position with respect to the vessel 18. In other embodiments, at least the second blower 22, and possibly the first blower 20, may be pivotable or displaceable with respect to the vessel 18. In the present embodiment, both blowers 20 and 22 are in the form of air knives.

In this specification, the expression “air knife” is used to designate equipment which generates a high-intensity, uniform sheet of laminar flow of air or other gas. Although air is the most common gas used in air knives, the expression as used in this specification is intended to embrace the use of gases other than air.

Such equipment commonly comprises a pressurized plenum containing a series of holes or continuous slots through which pressurized air exits in a laminar flow pattern. The exit air velocity then creates an impact air velocity onto the surface of an article at which the air is directed. This impact air velocity can range from a gentle breeze to greater than Mach 0.6 (40,000 ft/min) to remove loose material or liquid from the surface of an article without mechanical or operator contact.

The first air knife 20 discharges air generally horizontally across the top of the vessel 18, in the form of a sheet 21 of laminar flow which covers all, or nearly all, of the area of the opening 19. The second air knife 22 is disposed on the opposite side of the vessel 18 from the first air knife 20, and is directed to discharge air as a sheet 23 obliquely downwards, i.e. inwardly of the vessel 18. The angle of discharge may be not less than 30° and not more than 60° to the horizontal, the precise angle depending on the geometry of the particular cores 7 being treated.

The fixture 6 is conveyed by the transport carrier 4 along the rail 2 through the transfer region 15 from the dipping station 12 to a position above the vessel 18 at the excess urea removal station 16. From this position, the fixture 6 is lowered by the lifting and lowering mechanism 44 into the vessel 18 and so initially passes through the sheet of air 21 discharged from the first air knife 20 and subsequently moves through the obliquely directed sheet of air 23 issuing from the second air knife 22.

The region 15 above the molten urea bath 14 and the vessel 18 is relatively cool by comparison with the molten urea in the vessel 14 and so some solidification of the urea on the ceramic cores 7 carried by the fixture 6 will occur. The air temperature within the vessel 18 is maintained above the melting point of the urea (i.e. above 134° C.) in order that the urea carried by the cores 7 on the fixture 6 either re-melts or remains molten. In order to achieve this, the air 21, 23 discharged by the air knives 20, 22 is heated to an elevated temperature, for example about 170° C. The sheet 21 of heated air blown across the top opening 19 of the vessel 18 by the first air knife 20 screens the interior of the vessel 18, constituting a removal region, from the ambient surroundings, so maintaining the elevated temperature within the vessel 18. Thus the air sheet 21 serves as a “pneumatic lid” which restricts air from the transfer region 15 from being drawn into the vessel 18 and also helps recirculation of hot air within the vessel 18. While the first and second air knives 20 and 22 may be provided with heated air from a common source, the second air knife 22 may draw in air from within the vessel 18, so that its intake air has been preheated by the output of the first air knife 20.

As the fixture 6 is lowered through the sheets of air 21, 23 issuing from the air knives 20 and 22, the impact of the high-speed air on the surfaces of the cores 7 blows excess urea from the cores 7. The impact of the air will also eject urea from holes and other indentations in the cores 7, while leaving in place urea that has penetrated into the pores of the cores 7. The downward inclination of the second air knife 22 ejects removed urea towards the bottom of the vessel 18, for subsequent collection. The elevated temperature within the vessel 18 and the hot air issuing from the air knives 20 and 22 re-melt any urea on the surfaces of the cores 7, or in any holes or indentations in the cores 7, so that it can be detached reliably from the cores 7 and deposited in the vessel 18. The orientation of the air knives 20, 22 establishes a turbulent airflow within the vessel 18, which assists in the rapid heating, re-melting and removal of the excess urea.

In certain embodiments, the velocity of the air discharged from the air knives 20, 22 at the cores 7 may be in excess of 5 metres/second at the surfaces of the cores 7. For example, the velocity of the air may be in the range 6 to 8 metres/second, and may be 7 metres/second or higher.

To ensure complete removal of excess urea, the fixture 6 may be raised and lowered several times by the lifting and lowering mechanism 44, for example two or three times, to effect several passes of the cores 7 through the air sheets 21, 23 created by the air knives 20, 22.

FIG. 3 is a top view of an alternative arrangement of the vessel shown in FIG. 2. In the embodiment of FIG. 3, the first air knife 20 is replaced by a partial covering of the opening 19 of the vessel 18 by partitions 24 which separate the interior of the vessel from the ambient surroundings including the transfer region 15. The partitions 24 leave a gap 26 between them which is sufficient to allow the passage of the fixture 6 carrying the ceramic cores 7. The fixture 6 thus passes into the vessel 18 so that excess urea can be removed using only a single obliquely directed air knife 22. It will be appreciated that the partitions 24 could be employed in addition to the first air knife 20 of FIG. 2.

Following urea removal in the vessel 18, the fixture 6 is raised above the excess urea removal station 16 by the lifting and lowering mechanism 44 and transported along the rail 2 to an unloading station 28 at which the fixture 6 is released from the transport carrier 4 and the ceramic cores 7 are removed from the fixture 6, possibly after a cooling period.

In a specific example of a process as described above, the ceramic cores 7 are retained in the molten urea bath 14 for a period of 60 seconds, which is a sufficient time to enable adequate penetration of the molten urea into the pores in at least the surface region of the ceramic cores 7, Although impregnation throughout the entire core 7 may occur. It has been found in practice that ceramic cores 7 having relatively thin sections (thickness of around 2 mm or less) lose heat relatively quickly and will cool to a temperature below 134° C. in less than 10 seconds after removal from the urea bath 14 and while travelling through the transfer region 15. By maintaining the ambient temperature within the vessel 18 above 134° C., for example at a temperature between 134 and 140° C., and holding the ceramic cores 7 within the vessel 18 for 60 seconds, full re-melting and removal of the excess urea was achieved, without any leaching out of absorbed urea from pores of the ceramic cores 7.

The fixture 6 is shown in greater detail in FIG. 4. It comprises a frame 28 fabricated from an upper crossbar 30, a pair of lower crossbars 32, a central crossbar 34 and a pair of parallel uprights 26. In this disclosure, references implying a direction, such as “upper”, “lower”, “horizontal” and vertical”, relate to the fixture 6 and cores 7 held by it in the normal upright orientation when the fixture 6 and cores 7 progress through the process illustrated in FIG. 1.

The lower crossbars 32 are spaced apart by a short distance (6 mm in the embodiment shown) to form a slot 38. The upper and lower crossbars 30, 32 are made from square cross-section metal bar oriented with their diagonals directed horizontally and vertically. This has the effect that the lower crossbars 30 form a channel 39 which tapers downwardly towards the slot 38.

The upper crossbar 30 is provided with a pair of fittings 40 shaped for engagement by corresponding fittings on the transport carrier 4, to enable the fixture 6 to be raised, lowered and conveyed along the rail 2.

The central crossbar 34 is provided with a row of clamping devices in the form of clamps 42 for holding the ceramic cores 7. Each clamp 42 is supported on the central crossbar 34 and is sufficiently versatile to grasp ceramic cores 7 of different geometries. Differently sized clamps 42 may be employed to suit different core geometries.

Each clamp 42 comprises a pair of resilient arms 44 which are mounted as mirror images of each other on the crossbar 34. One of the arms 44 is shown in FIG. 6. It is made from relatively thin steel wire, for example with a diameter of 2 mm. The arm is connected, for example by welding, to the crossbar 34 at one end 46. From the end 46 the arm proceeds around an arc 48 to an oblique straight section 60 followed by a downwardly directed straight section 62. At the lower end of the downwardly directed straight section 62 there is a contact foot 64 terminating at a core contact end 66.

As shown in FIGS. 4 and 5, the two arms 44 of each clamp 42 are fixed at their ends 46 to the crossbar 34 at the same position along the crossbar 34 but extend to opposite sides of the crossbar 34. They cross each other at approximately the junction between the straight sections 60 and 62. In the unstressed condition shown in FIG. 5, the downwardly directed sections 62 extend parallel to each other, and the contact feet 64 overlap each other are oppositely directed.

The arms 44 of clamps 42 can be resiliently deflected by hand, pivoting them about the welded joints at the crossbar 34, to move the contact feet apart so that a core 7 can be inserted between them. When released, the arms 44 spring back to grasp the core 7 between the contact ends 66.

The clamps 42 are able to hold a variety of different components, such as HP turbine blades, nozzle guide vanes and seal segments. In a specific embodiment, the clamps are able to grasp seven components of different geometries, having a depth in the plane of FIG. 5 of from 7 to 20 mm, a width in the plane of FIG. 4 up to 80 mm, and a length (parallel to the uprights 36) from 90 to 120 mm.

The V-shaped convergent channel 39 leading to the slot 38, and defined by the oppositely disposed oblique upper faces of lower crossbars 32, serves to locate the ceramic cores 7 grasped by the clamps 42, so that their weight can be taken by the lower crossbars 32, ensuring good contact with the lower crossbars 32. The clamps 42 make point contact only with the cores 7 (i.e. contact over a small area), so that the clamps serve to hold the cores 7 in an upright orientation with minimal damage to the core surface. The slot 38 allows the flow of molten urea, and so assists the removal of excess molten urea displaced from the ceramic cores 7 by the air knives 20, 22. The cross members 30, 32, 34 and the uprights 36 are made from solid metal and so retain heat. This assists in keeping the ceramic cores 7 hot as they are displaced along the processing line shown in FIG. 1 from the pre-heating station 10 through the dipping station 12 and thence to the excess urea removal station 16. This minimises the energy required to reheat the ceramic components after exposure to the cooler ambient surroundings in the transfer region 15.

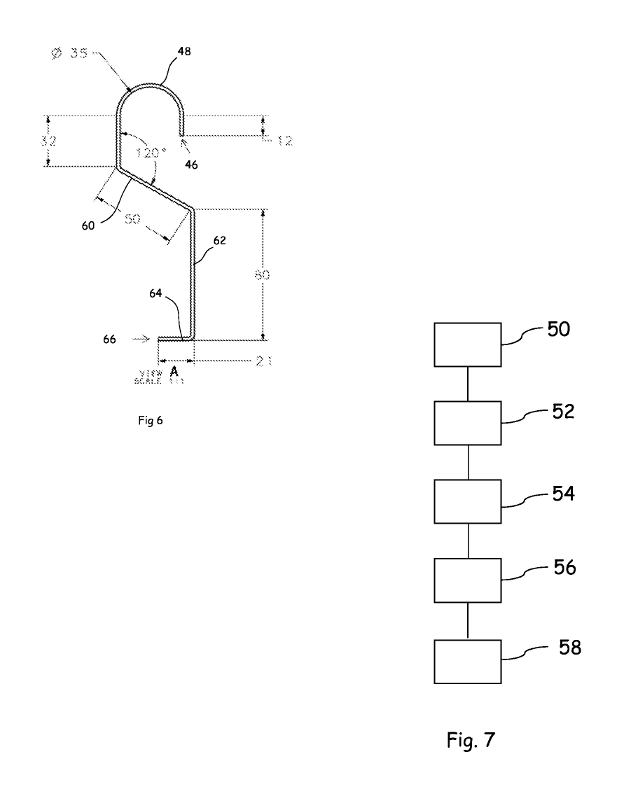

FIG. 7 is a flow chart summarising the impregnation process described above. Referring to FIG. 7, a loading step 50 takes place at the loading station 8, at which the ceramic cores 7 are loaded onto the fixture 6 by positioning the lower ends of the ceramic cores 7 on the lower support 32 and engaging upper regions of the ceramic cores 7 by the clamps 42. This process can be conducted manually by an operator. The clamps 42 engage the cores 7 only over the small areas occupied by the contact ends 66, so leaving the rest of the core 7 uncovered. The small diameter of the wire forming the arms 44 means that only a small contact pressure is exerted on the cores 7, avoiding any damage to them.

The fixture 6 is subsequently engaged by the transport carrier 4 and raised, by means of the lifting and lowering mechanism 44. The transport carrier 4, with the fixture 6 loaded with the cores 7 is then conveyed along the rail 2 to the pre-heating station 10, where a pre-heating step 52 occurs.

Subsequently, the fixture 6 is transported along the rail 2 to the dipping station 12 where a dipping step 54 takes place. In the dipping step 54, the transport carrier 4 with the fixture 6 is lowered by the lifting and lowering mechanism 44 to immerse the cores 7 in the urea -containing bath 14.

The fixture 6 is then raised from the bath 14 and transported along the rail 2 to the excess urea removal station 16 where the cores 7 are subjected to an excess urea removal step 56 in the enclosure 18. In this removal step 56, the fixture 6 carrying the cores 7 is lowered into, and raised from, the enclosure 18 by the lifting and lowering mechanism 44 at least once, and possibly two, three or more times.

After the removal step 56 is complete, the fixture 6 is transported along the rail 2 to the unloading station 28, where the cores 7 are manually removed from the fixture 6 for further use, and in particular for use in an investment casting process.

The processing line and impregnation process described above eliminate the need for human intervention in the urea dipping process and in the subsequent removal of excess urea, once the components have been loaded onto the fixture 6 and the fixture 6 has been loaded onto the transport carrier 4. Thus, the risks of operator exposure to molten urea are eliminated. The process line may be enclosed in a canopy, reducing the escape of heat and avoiding operator exposure to toxic substances released on decomposition of the molten urea.

Although only one transport carrier 4 is shown in FIG. 1, there may be a plurality of transport carriers arranged along the rail 2, with only a single operator being required to load and unload the fixtures 6 at positions away from the molten urea itself.

Because the excess urea removal station 6 operates in an automated and therefore consistent manner, the process shown in FIG. 1 achieves consistency in the quality of impregnated ceramic cores 7, as compared with “hand dabbed” cores, which may have different levels of solidified urea on their surfaces. Furthermore, the automatic process shown in FIG. 1 achieves low or zero breakage of, or damage to, delicate components, owing to the excess urea removal by way of air knives 20, 22 rather than by hand dabbing.

Although the process has been described above in connection with urea impregnation of ceramic cores, it will be appreciated that similar processes can be used for dipping other components in a variety of compositions, where subsequent wiping of excess composition is required.

It will be appreciated that the fixture 6 shown in FIGS. 4 and 5 can be employed in a variety of processes where there is a requirement to hold delicate components via point contact in a manner which is secure enough to withstand strong airflow or similar forces.

Thus, it will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

We claim:

1. A carrier for holding a plurality of articles during displacement to and from a dipping position, at least, the carrier comprising a frame having an elongate lower support for supporting a row of the articles, and having an upper support provided with clamping devices for holding the articles at positions above the lower support, the lower support having a drainage aperture for the drainage of liquid from the articles, and the carrier further comprising a mounting arrangement for mounting the carrier on a conveyor.

2. The carrier as claimed in claim 1, wherein the drainage aperture comprises a slot extending lengthwise of the lower support.

3. The carrier as claimed in claim 2, wherein the width of the slot is not less than 5 mm and not more than 10 mm.

4. The carrier as claimed in claim 2, wherein the lower support comprises a pair of parallel bars which are spaced apart to define the drainage slot.

5. The carrier as claimed in claim 4, wherein the bars are solid metal components.

6. The carrier as claimed in claim 4, wherein the bars are of quadrilateral cross-section oriented so that oppositely disposed surfaces of the respective bars define a downwardly convergent channel.

7. The carrier as claimed in claim 1, wherein each clamping device comprises a pair of arms provided with contact ends for engagement with an article, the arms being resiliently displaceable relatively to each other to move the contact ends (66) apart.

8. The carrier as claimed in claim 7, wherein the arms are made from metallic wire.

9. The carrier as claimed in claim 8, wherein the contact ends comprise end faces of the metallic wire.

10. The carrier as claimed in claim 7, wherein the arms are secured at respective ends away from the contact ends to the upper support.

11. The carrier as claimed in claim 10, wherein the arms are secured to the upper support by welding.

12. An article dipping system comprising a bath of liquid, a conveyor, and at least one carrier as claimed in claim 1, the carrier being mounted on the conveyor for displacement to and from a dipping position over the bath, and the conveyor being equipped with a lowering mechanism operable at the dipping position to immerse in the liquid articles carried by the carrier.

13. The article dipping system as claimed in claim 12, wherein the system further comprises an excess liquid removal station, the conveyor being operable, after immersion of the articles, to raise the carrier from the bath and to convey the carrier to the excess liquid removal station.

14. A carrier for holding a plurality of articles, the carrier comprising a frame having an elongate lower support for supporting a row of the articles, and having an upper support provided with clamping devices for holding the articles at positions above the lower support, the lower support having a drainage aperture for the drainage of liquid from the articles, and the carrier further comprising a mounting arrangement for mounting the carrier on a conveyor.
